(19) United States
(12) Patent Application Publication
(10) Pub. No.: US 2011/0317179 A1
(43) Pub. Date: Dec. 29, 2011

(54) PRINTER DEVICE AND PRINTER SYSTEM

(76) Inventor: Shuping NG, Alexandra Technopark (SG)

(21) Appl. No.: 13/255,123

(22) PCT Filed: Jun. 30, 2009
(86) PCT No.: PCT/JP2009/003016

§ 371 Date: Sep. 7, 2011

(30) Foreign Application Priority Data
Mar. 19, 2009 (JP) 2009-068533

(51) Int. Cl. G06K 15/02

(52) U.S. Cl. 358/1.6

(57) ABSTRACT

A printer device for printing character strings of a data item having the same content in a plurality of languages. The character strings are of a data item which is predetermined in each of a plurality of fields (FIELD 1, FIELD 2, FILED 3, . . . ) arranged in a predetermined format of a label. A preset data storage stores preset data representing the character strings of the data item to be printed in each of the fields, in respective languages (LANGUAGE 1, LANGUAGE 2), respectively. The predetermined character strings of the data item in the fields of the label are printed in one or more languages selected out of the plurality of languages on the basis of the present data.

### CROSS-REFERENCE TO RELATED APPLICATIONS

The present application is a 35 U.S.C. §§371 national phase conversion of PCT/JP2009/003016, filed Jun. 30, 2009, which claims priority of Japanese Application No. 2009-068533, filed Mar. 19, 2009, the contents of which are incorporated by reference herein. The PCT International Application was published in the Japanese language.

### TECHNICAL FIELD

The present invention relates to a printer device capable of printing character strings of data items that have been previously determined respectively for a plurality of fields that are arranged according to a predetermined label format, and to a printer system provided with the printer device.

Conventionally, there is known a printer device that prints character strings of data items relating to an article for sale such as a material, name, price, and manufacturing date on a label (see Japanese Unexamined Patent Application Publication No. 2001-31039). Such a printer device stores format data indicating an arrangement of a plurality of fields (printing regions) on a label, and preset data indicating character strings of data items to be printed respectively in the plurality of fields. Then, the printer device prints the character strings of the data items assigned to the respective fields on the label according to the format data and the preset data.

In areas (countries) where people of different nationalities live, it is often desired that character strings of data items carrying the same meaning in a plurality of languages are printed. In this case, the conventional printer device first performs printing of a required number of labels according to preset data indicating the character strings of the respective data items in one language (e.g., English), then rewrites the preset data into preset data for a different language (e.g., French), and performs further printing of a required number of labels according to the latest preset data.

### SUMMARY OF INVENTION

### Technical Problem

However, according to the conventional printer device, as it is necessary to rewrite preset data that is internally stored for every switch in a language for character strings to be printed on labels, the switching operation between languages is cumbersome.

The present invention is made in view of the above situation. An object of the present invention is to provide a printer device capable of printing character strings of data items carrying the same meaning in a plurality of languages.

### Solution to Problem

A printer device according to the present invention is capable of printing character strings of data items that have been previously determined respectively for a plurality of fields that are arranged according to a predetermined label format. The printer device includes: preset data storage by storing means for storing preset data in which character strings of data items to be printed respectively in the plurality of fields are expressed in a plurality of languages. The printer device is programmed such that based on the preset data the character strings of the data items that have been previously determined respectively for the plurality of fields of the label are printed in one or more languages selected from the plurality of languages.

According to this structure, the preset data in which the character strings of the data items to be printed respectively in the plurality of fields are expressed in the plurality of languages and the data is stored in the preset data storage. Therefore, selectively using the needed character strings of the data items expressed in the one or more languages from the preset data enables printing the character strings expressed in the one or more languages that are needed respectively in the plurality of fields of the label.

Further, for a field for which a character string of a data item is common to the plurality of languages in the preset data, the common character string can be expressed only in a single language.

According to this structure, there are no overlaps in the data items (e.g., manufacturing date and such) sharing a character string in the plurality of languages in the preset data, this reduces a data amount of the preset data smaller. As a result, it is possible to save the capacity of a memory of the printer device.

Moreover, in the printer device of the present invention, preset data supplied externally to the printer device can be stored in the preset data storage. In this case, the preset data can be provided via a predetermined network in response to a request from the printer device, via a user interface such as an operation unit, or via a recording medium.

Furthermore, the printer device according to the present invention further may include: determining means of determining, for each of the plurality of fields in the label, whether to print in the one language or in the more than one language that have been selected from the plurality of languages. According to a determination by the determining means, the character strings of the data items that have been previously determined respectively for the plurality of fields of the label are printed in the one or more languages selected from the plurality of languages.

This structure makes it possible to print, in each field in the label, the character string of the data item that has been previously determined for this field in the one or more languages.

A printer system according to the present invention includes: one of the printer devices described above; a control device connected to the printer device, and including: original preset data acquiring means of acquiring original preset data in which character strings of data items to be printed respectively in a plurality of fields that are arranged according to a predetermined label format are expressed in a plurality of languages; preset data extracting means for extracting preset data from the acquired original preset data, the extracted preset data relating to more than one language necessary for the printer device; and transmitting means for transmitting the extracted preset data relating to the more than one language to the printer device, wherein the printer device stores the preset data relating to the more than one language that has been transmitted from the control device in the preset storage.

According to this structure, only the preset data that had been extracted from the original preset data, in which the character strings of the data items to be printed respectively in the plurality of fields that are arranged according to the predetermined label format are respectively expressed in the plurality of languages, and relating to the more than one language necessary for the printer device is provided for the printer device. Accordingly, the printer device does not have to hold the preset data (original preset data) expressed in all languages. Further, it is possible to update the preset data used by the printer devices respectively in the plurality of printer systems only by collectively updating the original preset data.

The control device can be provided separately from the printer device, or can be implemented as a function of the printer device.

The original preset data acquiring means can be configured to acquire the original preset data from a recording medium such as a CD-ROM, or to include means of receiving the original preset data transmitted via a predetermined network.

### Advantageous Effects of Invention

According to the printer device of the present invention, by selectively using the character strings of the data items expressed in the one or more languages that are needed from the preset data in which the character strings of the data items to be printed respectively in the plurality of fields are expressed in the plurality of languages, it is possible to print the character strings expressed in the one or more languages that are needed respectively in the plurality of fields on the label. Therefore, it is not necessary to rewrite the preset data every time the language to be used is changed, and it is possible to easily print the character strings of the data items carrying the same meaning in the plurality of languages on the label.

Further, according to the printer system of the present invention, as the printer device does not have to hold the preset data (original preset data) expressed in all languages, it is possible to reduce the capacity of the memory for storing the preset data in the printer device. Moreover, as it is possible to update the preset data used by the printer devices respectively in the plurality of printer systems only by collectively updating the original preset data in the host system, it is possible to improve the efficiency in the update operation.

Furthermore, according to the printer system of the present invention, names corresponding to languages of different countries of the same item (e.g., name of product) to be printed carry the same meaning in the original preset data. Therefore, it is possible to issue a label on which, for example, along with the name of the product expressed in Japanese, the name of the product expressed in another language, for example, Korean, is printed by the printer device. Accordingly, it is possible to prevent names of the same item from being expressed wrongly between the different languages, and it is possible to eliminate confirming the description even when a Japanese worker who cannot read Korean applies labels on products.

### BRIEF DESCRIPTION OF DRAWINGS

FIG. 1 is an illustration of printer systems each provided with a printer device according to one embodiment of the present invention.

FIG. 2 is a block diagram illustrating an example of a structure of the printer device.

FIG. 3 is a sequence chart showing a flow of a process between a control device and the printer device.

FIG. 4 is a table showing one example of original preset data.

FIG. 5 is a table showing another example of the original preset data.

FIG. 6 is a table showing one example of preset data stored in the printer device.

FIG. 7 is a flowchart showing a flow of a printing process in the printer device.

FIG. 8 is a table showing another example of the preset data.

FIG. 9 is an illustration of one example of a label printed according to the preset data shown in FIG. 8.

FIG. 10 is a flowchart showing another flow of the printing process in the printer device.

### DETAILED DESCRIPTION OF PREFERRED EMBODIMENTS

The following describes an embodiment of the present invention with reference to the drawings.

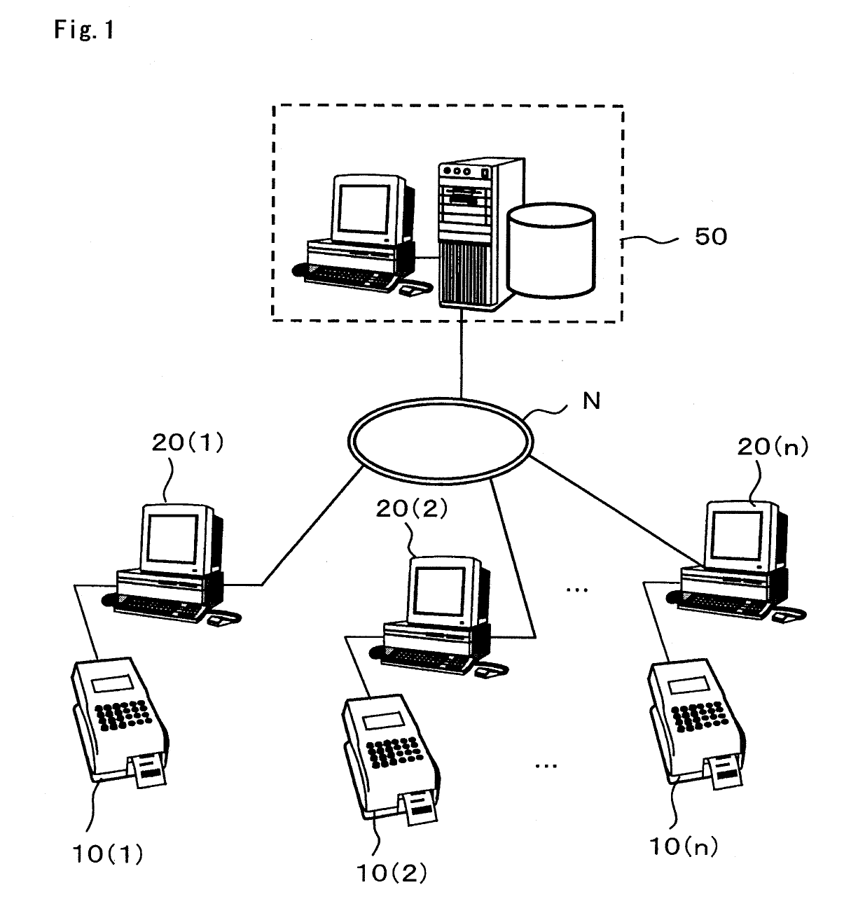

A printer system provided with a printer device according to one embodiment of the present invention is configured as shown in FIG. 1.

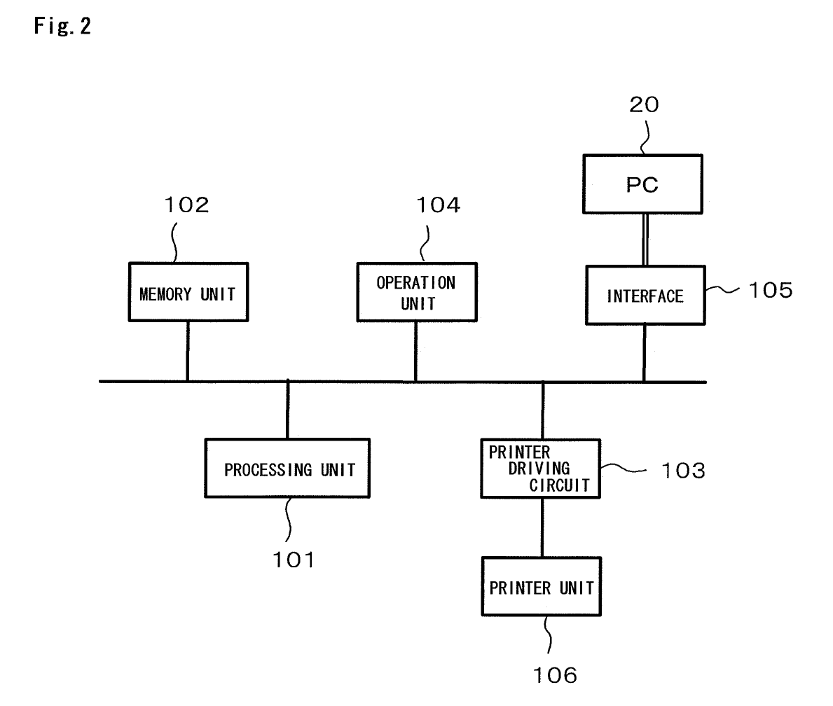

Referring to FIG. 1, for example, a host system 50 may be installed at any location for example, in a head office, and a printer device 10(1) and a control device 20(1) connected to the printer device 10(1), a printer device 10(2) and a control device 20(2) connected to the printer device 10(2), . . . , and a printer device 10(n) and a control device 20(n) connected to the printer device 10(n) are installed at any selected locations, for example in shops in various regions (countries). Each of the control devices 20(1), 20(2), . . . , and 20(n) is configured of a personal computer (PC) and such other data input device, and connected to the host system 50 via a predetermined network N (e.g., the Internet). Each printer device 10 (the reference number 10 collectively represents the reference numbers 10(1), 10(2), . . . , and 10(n), and hereinafter the same applies) is configured as shown in FIG. 2, for example.

Referring to FIG. 2, the printer device 10 is provided with a processing unit 101 (CPU), a memory unit 102, a printer driving circuit 103 configured to actuate a printer unit 106 that performs label printing, an operation unit 104, and an interface 105 connected to a control device 20 (the reference number 20 collectively represents reference number 20(1), 20(2), and so on, and hereinafter the same applies). These components are connected with each other via a bus, for example. The processing unit 101 is configured to execute a process according to a signal based on an operation of the operation unit 104. Further, the processing unit 101 is configured to perform data transmission and reception with the control device 20 (PC) via the interface 105. The memory unit 102 is configured to store various data necessary for the process by the processing unit 101.

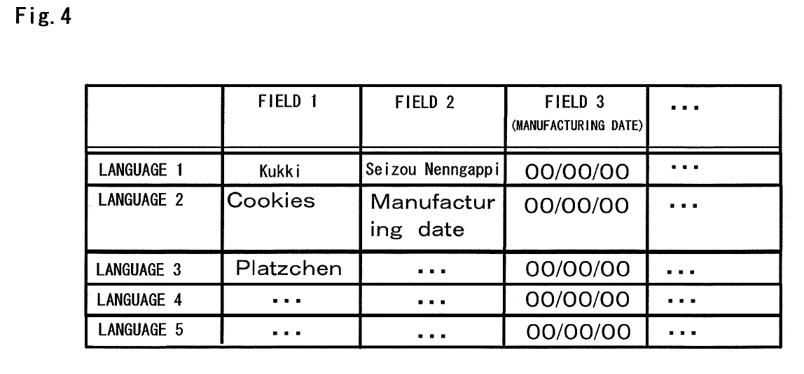

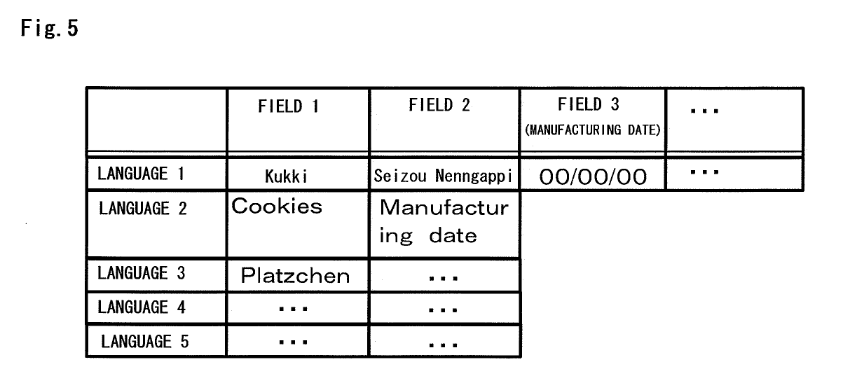

In the host system 50, there is original preset data in which character strings of data items to be printed respectively in a plurality of fields are arranged according to a predetermined label format and is generated and stored. They are expressed in a plurality of languages. The original preset data is defined as shown in FIG. 4, for example, in which: character strings for a data item “Product Type” to be printed in a field 1 are defined as “Kukki” in a language 1, “Cookies” in a language 2, “Platzchen” in a language 3, and so on, character strings for a data item “Subject for Date Field” to be printed in a field 2 are defined as “Seizou Nenngappi” in the language 1, “Manufacturing Date” in the language 2, and so on, and character strings for a data item “Date” to be printed in a field 3 are defined as “00/00/00” in Arabic numbers in all languages. However, as the character strings for the data item “Date” to be printed in the field 3 are the same for all languages (common character string), it is possible to define such a data item only in a single language, for example, only in the language 1 as shown in FIG. 5.

Then, the control device 20 acquires the original preset data delivered from the host system 50 (see FIG. 4 or FIG. 5) via the network N (original preset data acquiring means). Here, while the original preset data in the host system 50 is editable, it is restricted to edit the original preset data once the control device 20 acquires the original preset data from the host system 50.

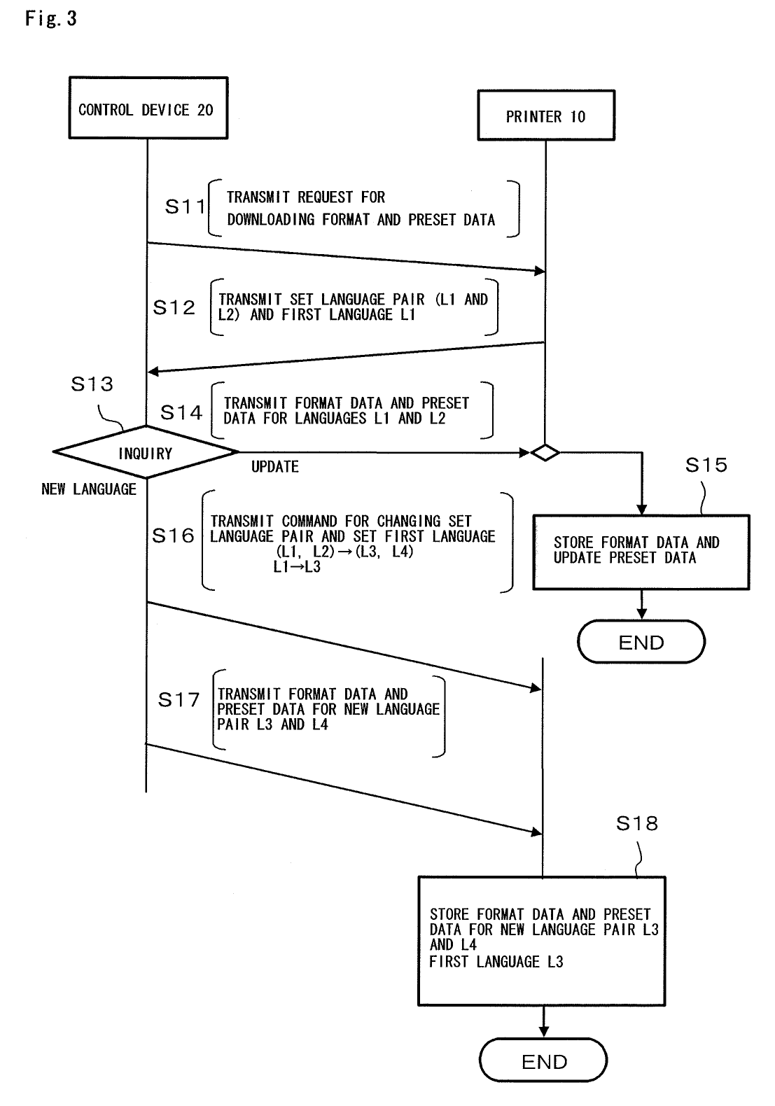

After the control device 20 acquires the original preset data, a process between the control device 20 and the printer device 10 is carried out according to a flow shown in FIG. 3, for example.

Referring to FIG. 3, the control device 20 transmits a request for downloading format data and preset data to the printer device 10, the format data indicating a printing format of labels to be printed (such as information of a field arrangement and a number of languages (1 or 2) to be printed in the respective fields) (S11). Upon reception of the request for downloading, the printer device 10 transmits data, to the control device 20, indicating two languages including a language L1 (first language) and a language L2 that are currently being set (S12). The control device 20 displays the acquired data in a display unit that is not depicted in the drawings, and inquires of an operator whether to update the languages L1 and L2, or to newly transmit languages L3 and L4 (S13).

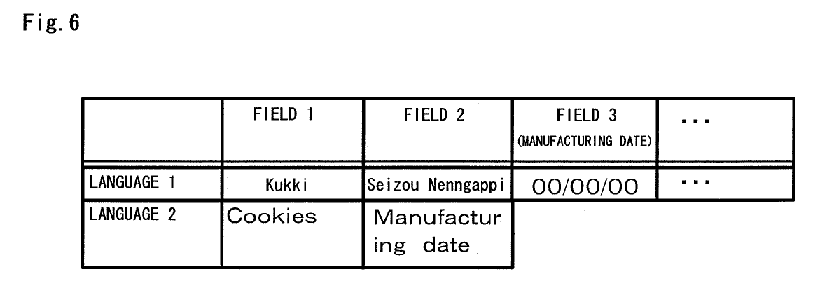

When it has been selected to update the languages L1 and L2, the control device 20 extracts the format data and the preset data corresponding to the languages L1 and L2 (see FIG. 6) from the original preset data recorded in the control device 20, and transmits the extracted data to the printer device 10 (preset data extracting means) (S14). Upon reception of the format data and the preset data from the control device 20, the printer device 10 stores the format data in the memory unit 102 (preset data storing means), and updates a content of the preset data regarding the languages L1 and L2 that is already stored based on the received preset data regarding the languages L1 and L2 (S15).

On the other hand, when it has been selected to newly transmit the languages L3 and L4 to the printer device 10, the control device 20 transmits a command to switch to the two languages and the first language that are to be newly set to the printer device 10 (S16). Then, the control device 20 extracts the format data and the preset data corresponding to the languages L3 and L4 (see FIG. 6) from the original preset data recorded in the control device 20, and transmits the extracted data to the printer device 10 (preset data extracting means) (S17). Then, the printer device 10 stores the new format data and preset data of the two languages L3 and L4 in the memory unit 102 (preset data storing means) in place of the previous format data and preset data (the languages L1 and L2), and sets the language L3 as the first language (S18). This allows the printer device 10 to perform printing of labels using the new preset data in the languages L3 and L4 (see FIG. 6).

In this case, when the preset data as shown in FIG. 6 is stored in the memory unit 102 of the printer device 10, the data item “Manufacturing Date” whose character string is common to the two languages is defined only in the language 1. This makes a data amount of the preset data relatively small, and consequently it is possible to save the capacity of the memory unit 102.

Further, according to the printer system configured by the control device 20 and the printer device 10, as the printer device 10 does not have to hold the preset data expressed in all languages (original preset data), it is possible to reduce the capacity of the memory unit 102 for storing the preset data (preset data storing means) in the printer device 10. Moreover, as it is possible to update the preset data used by the printer device 10 in each printer system only by collectively updating the original preset data in the host system 50, it is possible to improve the efficiency in the update operation.

According to the embodiment described above, the original preset data in which the character strings of the data items to be printed are expressed in the plurality of languages is generated in the host system 50, and the original preset data is delivered to the control device 20 of each printer system from the host system 50 via the network N. However, original preset data generated by one computer (PC) can be recorded in a recording medium such as a CD-ROM, and then the recorded original preset data can be provided for the control device 20 of each printer system by way of the recording medium.

Further, according to the embodiment described above, the control device 20 acquires the original preset data delivered from the host system 50 (see FIG. 4 or FIG. 5), and the printer device 10 transmits the two languages L1 and L2 that are currently set along with the language L1 as the first language to the control device 20 in response to the download request by the control device 20, and receives either the preset data for updating the two languages L1 and L2 (see FIG. 6) or the preset data for replacing with the languages L3 and L4 (see FIG. 6). However, it is possible to configure such that the printer device 10 directly communicates with the host system 50.

In the system structure in which the printer device 10 and the host system 50 directly communicate with each other via a predetermined network, in response to a request from the printer device 10 for the preset data for the two languages, the host system 50 can generate the preset data for the two languages relating to the request from the original preset data, and deliver the generated preset data to the printer device 10. In this case, it is possible to make an alteration appropriately such that the selection between the languages L1 and L2, and the languages L3 and L4 can be performed using the operation unit 104 of the printer device 10.

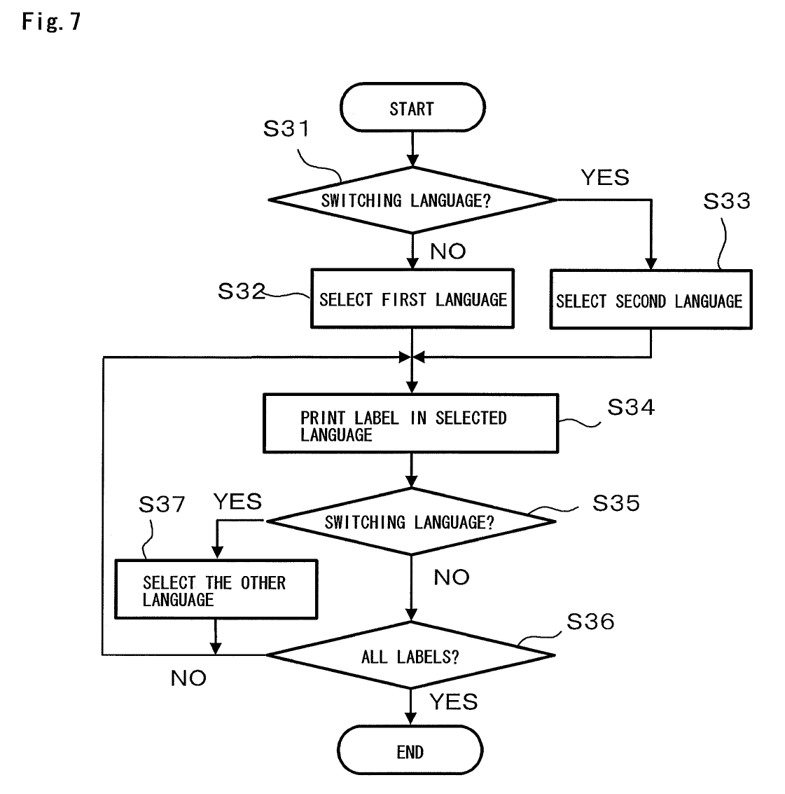

The printer device 10 that stores the format data and the preset data in the memory unit 102 in this manner performs the printing process according to a procedure as shown in FIG. 7, for example.

Referring to FIG. 7, the printer device 10 determines whether or not an operation of switching the languages has been made after starting up (S31). If the switching of the languages has not been made (NO in S31), the printer device 10 selects the previously set first language out of the two languages (S32), and performs the label printing using the preset data (e.g., see FIG. 6) and the format data stored in the memory unit 102 (S34). Specifically, when performing the label printing in the first language (the language 1) using the preset data shown in FIG. 6, “Kukki” in the field 1, “Seizou Nenngappi” in the field 2, a numerical string “00/00/00” in the field 3, and so on are printed on a label.

Subsequently, the printer device 10 determines whether or not the switching of the languages has not been made (S35), and whether or not printing of a set number of labels has been completed (S36). Then, if the switching of the languages has not been made (NO in S35) and if the printing of all the labels has not been completed (NO in S36), the printing of the next label is performed in the same manner (S34). Thereafter, until the printing is completed for all the labels (NO in S36), the printer device 10 continues the printing of the labels in the first language (the language 1) according to the preset data (S34). Upon completion of the printing of all the labels (YES in S36), the printer device 10 terminates the process of label printing.

On the other hand, if the switching of the languages has not been made after starting up of the printer device 10 (YES in S31), the printer device 10 selects a second language out of the two languages (S33), and performs the label printing using the preset data stored in the memory unit 102 (S34). Specifically, when performing the label printing in the second language (the language 2) using the preset data shown in FIG. 6, “Cookies” in the field 1, “Manufacturing Data” in the field 2, the numerical string “00/00/00” in the field 3, and so on are printed on a label. Then, as described previously, until the printing is completed for the set number of labels (YES in S36), the label printing is performed in the second language (the language 2) (S34, S35, and S36).

In the process of the label printing in the first language (the language 1) or in the second language (the language 2) as described above (S34-S36), when the switching of the languages is made (YES in S35), the language is switched to a language that is different from the currently selected language (S37), and the label printing is performed according to the preset data for the switched language.

According to the printer device 10 as described above, by selectively using the character strings of the data items expressed in the language that is needed from the preset data in which the character strings of the data items to be printed respectively in the plurality of fields are expressed in the two languages (see FIG. 6), it is possible to print the character strings expressed in the language that is needed respectively in the plurality of fields on the label (see the process flow in FIG. 7). Therefore, it is not necessary to rewrite the preset data every time changing the language to be used, and it is possible to easily print the character strings of the data items carrying the same meaning in the two languages on the label.

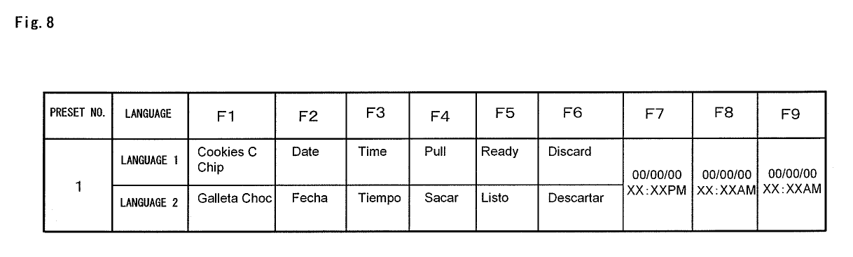

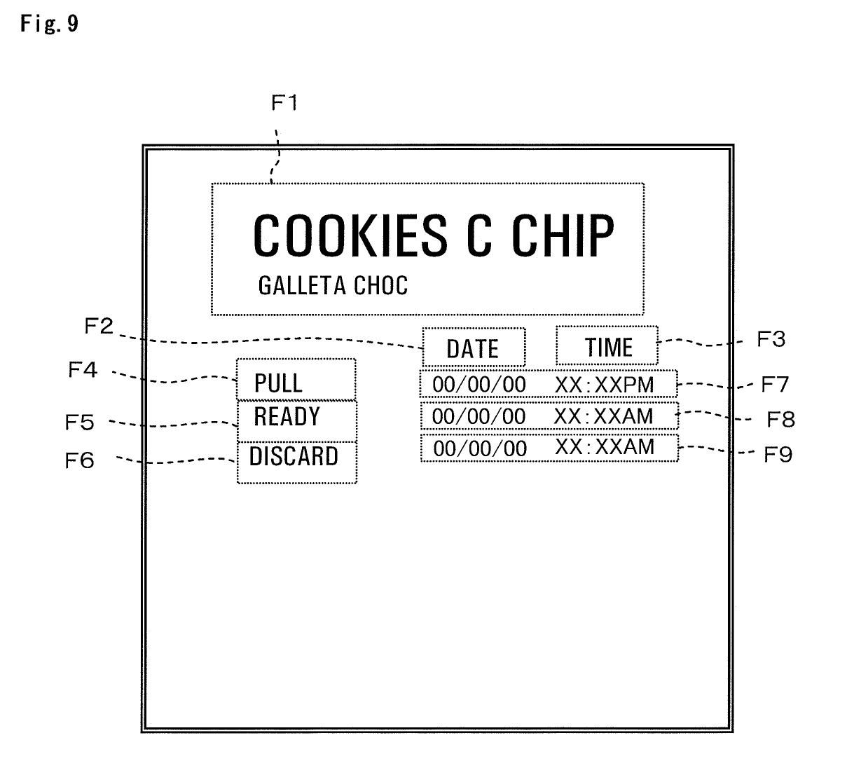

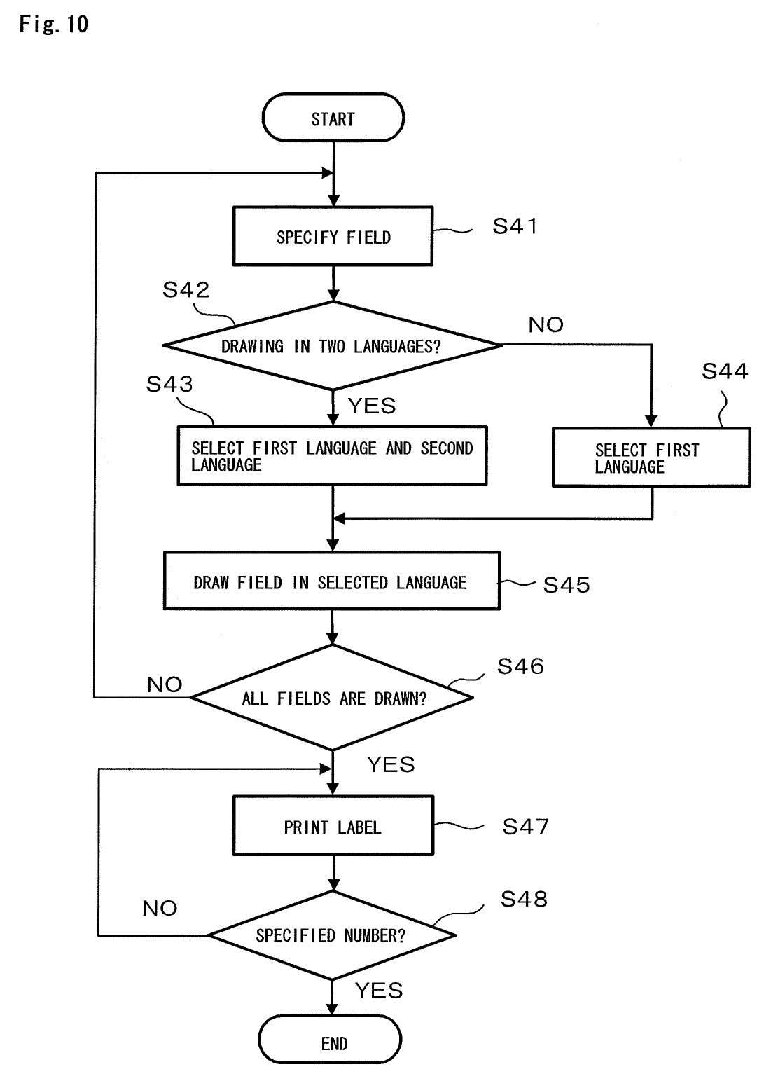

Further, unlike the above example, the printer device 10 can selectively execute, respectively for the plurality of fields, drawing in a single language (the first language) and drawing in two languages (the first language and the second language) based on a field attribute of the printing format that has been acquired along with the preset data. For example, it is possible to perform the label printing as shown in FIG. 9 using the preset data as shown in FIG. 8. Specifically, a character string “Cookies C Cip” in the first language (the language 1, English) and a character string “Galleta Choc” in the second language (the language 2, Spanish) for the same data item (Product Type) are drawn in the field 1 (F1), and the character strings “Date”, “Time”, “Pull”, “Ready”, “Discard”, “00/00/00 XX:XX PM”, “00/00/00 XX:XX AM”, and “00/00/00 XX:XX AM” are drawn and printed only in the first language (the language 1, English) in the other fields (F1-F9). Such label printing can be realized by the printing process according to the procedure in the printer device 10 shown in FIG. 10.

Referring to FIG. 10, the printer device 10 specifies a field on the label to be drawn (S41), and determines whether or not to draw the field attribute of the format data in two languages (S42). If the field attribute is to be drawn in two languages (YES in S42), the printer device 10 selects the first language and the second language (S43), draws the character string in the first language and the character string in the second language defined for the specified field in the preset data stored in the memory unit 102 (see FIG. 8) in the specified field on the label (S45). For example, the character string “Cookies C Chip” in the first language and the character string “Galleta Choc” in the second language defined for the field 1 (F1) in the preset data shown in FIG. 8 are drawn in the field 1 (F1) on the label (see FIG. 9).

Upon completion of the drawing to the specified field, the printer device 10 determines whether or not the drawing for all the fields has been completed (S46). If the drawing for all the fields has not been completed yet (NO in S46), the printer device 10 specifies the next field (S41), and determines whether or not to draw the next field attribute of the format data in two languages (S42). In this case, if the field attribute has not been determined to be drawn in two languages (NO in S42), the printer device 10 selects the first language (S44), and draws the character string in the first language defined for the specified field in the preset data stored in the memory unit 102 (see FIG. 8) in the specified field on the label (S45). For example, the character string (Date) in the first language defined for the field 2 (F2) in the preset data shown in FIG. 8 is drawn in the field 2 (F2) of the label (see FIG. 9).

Thereafter, the same process (S41, S42, S43 (S44), and S45) is repeatedly executed, and when it is determined that the drawing has been completed for all the fields of the label (YES in S46), the printer unit 106 performs printing and issuing (S47). Then, it is determined whether or not the issuing for the specified printing number has been completed (S48). If not completed (NO in S48), the printing and issuing (S47) is repeated, and if completed all the issuing (YES in S48), the process is terminated. As a result of this process, the specified number of labels printed as shown in FIG. 9 are issued, for example.

According to this printing process, by using the preset data in which the character strings of the data items to be printed in the plurality of fields are expressed respectively in two languages (see FIG. 8) based on the field attribute of the printing format that has been acquired along with the preset data, it is possible to selectively set the character strings in two languages or the character strings in a single language for each of the plurality of fields (see FIG. 9 and FIG. 10). Accordingly, it is possible to easily switch for each field between the printing in two languages and the printing in a single language.

According to the embodiment described above, the preset data used in each printer device 10 is for two languages. However, the preset data can be for more than two languages.

### INDUSTRIAL APPLICABILITY

The printer device according to the present invention provides an advantageous effect of being able to easily print the character strings of the data items carrying the same meaning in the plurality of languages, and is useful as a printer device that prints the character strings of the data items that have been previously determined respectively for the plurality of fields that are arranged according to the predetermined label format.

### REFERENCE SIGNS LIST

10, 10(1), 10(2), 10(n) Printer Device
20, 20(1), 20(2), 20(n) Control Device
50 Host System
101 Processing Unit
102 Memory Unit
103 Printer Driving Circuit
104 Operation Unit
105 Interface
106 Printer Unit

1. A printer device for printing character strings of data items that have been previously determined respectively for a plurality of data fields that are arranged according to a predetermined label format, the printer device comprising:
a preset data storage programmed for storing preset data in which character strings of data items to be selected for being printed respectively in the plurality of data fields are expressed in each field in a plurality of languages;
a determining program of the printing device operable for determining which of the fields of the data are to be printed and in which languages, wherein based on the stored preset data and the determination program, the printer device is operable so that the character strings of the data items that have been previously determined respectively for the plurality of fields of the label are printed in one or more languages selected from the plurality of languages.

2. The printer device according to claim 1, wherein for a field for which a character string of a data item is common to the plurality of languages in the preset data, the printer device is programmed such that the common character string is expressed only in a single language.

3. The printer device according to claim 1, wherein the preset data storage is configured to store the preset data and to supply the preset data externally to the printer device.

4. The printer device according to claim 1, further comprising:
the determining program being configured for determining, for each of the plurality of fields in the label format, whether to print in the one language or in the more than one language that has been selected from the plurality of languages, wherein according to a result of the determination by the determining means, the printer device is configured for printing the character strings of the data items that have been previously determined respectively for the plurality of fields of the label in the one or more languages selected from the plurality of languages.

5. A printer system comprising:
the printer device according to claim 1; and
a control device connected to the printer device, wherein
the control device includes:
an original preset data acquirer configured for acquiring the original preset data in which character strings of data items to be printed respectively in a plurality of fields that are arranged according to a predetermined label format are expressed in a plurality of languages;
a preset data extractor configured for extracting preset data from the acquired original preset data, wherein the extracted preset data relates to more than one language necessary for the printer device; and
a transmitter configured for transmitting the extracted preset data relating to the more than one language to the printer device, wherein
the printer device is configured to store the preset data relating to the more than one language that has been transmitted from the control device in the preset data storage.

6. The printer system according to claim 5, wherein
the original preset data acquire includes a receiver of original preset data transmitted via a predetermined network.

7. A method according for printing character strings of data items that have been previously determined respectively for a plurality of data fields that are arranged according to a predetermined label format, the method comprising:
storing preset data in which character strings of data items to be selected for being printed respectively in the plurality of data fields are expressed in each field in a plurality of languages;
determining which of the fields of the data are to be printed and in which languages;
based on the stored preset data and determining the printing of the character strings of the data items that have been previously determined respectively for the plurality of fields of the label to be printed in one or more languages selected from the plurality of languages and printing the determined data items.

8. A method according to claim 7, wherein for a field for which a character string of a data item is common to the plurality of languages in the preset data, printing the common character string is expressed only in a single language.
